(19) United States
(12) Patent Application Publication
(10) Pub. No.: US 2012/0289629 A1
(43) Pub. Date: Nov. 15, 2012

(54) METHOD FOR PREPARING THERMOPLASTIC COMPOSITIONS OF PLASTICIZED STARCH, AND SUCH COMPOSITIONS

(75) Inventors: René Saint-Loup, Lomme (FR); Jérôme Gimenez, Villeurbanne (FR); Didier Lagneaux, Bluffy (FR)

(73) Assignee: Roquette Freres, Lestrem (FR)

(21) Appl. No.: 13/522,123

(22) PCT Filed: Jan. 14, 2011
(86) PCT No.: PCT/FR2011/050072

§ 371 Date: Jul. 13, 2012

(30) Foreign Application Priority Data
Jan. 15, 2010 (FR) 1050273

(51) Int. Cl. C08L 3/00

(52) U.S. Cl. 524/53

(57) ABSTRACT

The present invention relates to a method for preparing novel thermoplastic amylaceous compositions, as well as to such thermoplastic amylaceous compositions.

The present invention relates to a method for preparing novel thermoplastic amylaceous compositions, and also to such thermoplastic amylaceous compositions.

The term “thermoplastic composition” is intended to mean in the present invention a composition which reversibly softens under the action of heat and hardens when cooling. It has at least one “glass transition” temperature (Tg) below which the amorphous fraction of the composition is in the brittle glassy state and above which the composition may undergo reversible plastic deformations. The glass transition temperature or one at least of the glass transition temperatures of the starch-containing thermoplastic composition of the present invention is preferably between 50° C. and 150° C. This starch-containing composition may, of course, be formed by means of the processes conventionally used in plastics technology, such as extrusion, injection molding, molding, blow molding and calendering. Its viscosity, measured at a temperature of from 100° C. to 200° C., is generally between 10 and 10⁶ Pa·s. Preferably, said composition is a “hot melt” composition, i.e. it can be formed without applying high shear forces, for example by simple flowing or by simple pressing of the molten material. Its viscosity, measured at a temperature of from 100° C. to 200° C., is generally between 10 and 10³ Pa·s.

Most of the thermoplastic compositions available on the market at the current time are derived from fossil raw materials. In the current context of climate change due to the greenhouse effect and global warming, of the upward trend in the costs of fossil raw materials, in particular of oil from which plastics are derived, of the state of public opinion in search of sustainable development, and of products that are more natural, cleaner, healthier and more energy efficient, and of the change in regulations and tax systems, it is necessary to have available novel thermoplastic compositions resulting from renewable resources which are suitable in particular in the field of plastics, and which are simultaneously competitive, designed from the outset to have only little or no negative impact on the environment, and technically as effective as the polymers prepared from raw materials of fossil origin. Starch constitutes a raw material that has the advantages of being renewable, biodegradable and available in large amounts at a price which is advantageous in comparison with oil and gas, that are used as raw materials for current plastics.

The incorporation of granular starch as a filler into polymer materials such as polyethylene has been known for about ten years. Before dispersion of the starch in the synthetic polymer, the granular native starch is generally dried to a moisture content of less than 1% by weight so as to reduce its hydrophilic nature, to facilitate the incorporation into the continuous matrix formed by the polymer and to stabilize the dispersion obtained. For this same purpose, starch has also been precoated with fatty substances (fatty acids, silicones, siliconates) or modified, at the surface of the grains, by grafting of hydrophobic groups such as siloxanes, or of reactive groups such as isocyanates. The materials thus obtained generally contain approximately 10%, at the very most 20%, by weight of granular starch since, above this value, the mechanical properties of the composite materials are unsatisfactory.

It has subsequently been envisioned to prepare materials, which are most commonly biodegradable, containing higher proportions of starch, the starch being generally, at a given moment of the process for preparing the material, plasticized with a plasticizer which may be water.

In this context, it has in particular been recommended to combine the (plasticized) starch with a biodegradable polymer such as, for example, poly(lactic acid) (PLA), polycaprolactone (PCL) and/or poly(butylene succinate adipate) (PBSA).

However, it is also generally required to used an agent capable of improving the interfacial interactions between the amylaceous polymer and the polyester, and in particular an agent of diisocyanate type as described in international application WO 97/03120 which recommends the preparation of starch derivatives by grafting of biodegradable polyesters (PLA and PCL) via diisocyanates. The biodegradable compositions obtained are completely single-phase, the starch having been made totally compatible with the grafted biodegradable polyester.

By way of more recent examples, mention may be made of:
the article entitled “Effects of Starch Moisture on Properties on Wheat Starch/Poly(Lactic Acid) Blend Containing Methylene Diphenyl Diisocyanate” by Wang et al., published in Journal of Polymers and the Environment, Vol. 10, No. 4, October 2002, which also relates to the compatibilization of a starch phase and a PLA phase by adding methylene diphenyl isocyanate (MDI);
the article by Yu et al., entitled Green Polymeric Blends and Composites from Renewable Resources, Macromol. Sym. 2007, 249-250, 535-539, which discloses the preparation of biodegradable materials by extrusion of a blend of gelatinized starch and of biodegradable polyesters (PLA, PCL and PBSA), containing methylene diisocyanate introduced either mixed with the starch or mixed with the biodegradable polyester;
the article entitled “Effect of Compatibilizer Distribution on the Blends of Starch/Biodegradable Polyesters” by Long Yu et al., Journal of Applied Polymer Science, Vol. 103, 812-818 (2007), 2006, Wiley Periodicals Inc, which describes the effect of methylene diphenyl diisocyanate (MDI) as a compatibilizing agent for blends of a starch gelatinized with water (70% starch, 30% water) and of a biodegradable polyester (PCL or PB SA);
the article entitled “Thermal and Mechanical Properties of Poly(lactic acid)/Starch/Methylene Diphenyl Diisocyanate Blending with Triethyl Citrate” by Ke et al., Journal of Applied Polymer Science, Vol. 88, 2947-2955 (2003), which also relates to the problem of incompatibility between starch and PLA. This document studies the effect of the use of triethyl citrate as a plasticizer for the PLA phase in starch/PLA/MDI blends.

With regard specifically to the preparation of compositions containing a high proportion of starch and a nonbiodegradable polymer, for example a polyolefin, mention may be made of the article entitled “The influence of citric acid on the properties of thermoplastic starch/linear low-density polyethylene blends” by Ning et al., in Carbohydrate Polymers, 67, (2007), 446-453, which studies the effect of the presence of citric acid on these thermoplastic starch/polyethylene blends. However, this document does not at any time envision the attachment of the plasticizer used (glycerol) to the starch or the polyethylene via citric acid.

In the context of its research aimed at developing biodegradable or nonbiodegradable polymer materials with a high starch content, the applicant has recently envisioned the introduction into a polymeric matrix, for example into a polyolefin matrix, of an amylaceous component plasticized beforehand with a suitable plasticizer. The method developed by the applicant, described in particular in international applications WO 2009/095622 and WO 2009/095618, filed on Jan. 29, 2009, comprises the thermomechanical mixing of a granular starch and of a plasticizer for preparing, by extrusion, granules of a thermoplastic amylaceous composition. The granules obtained are then incorporated into a matrix of molten synthetic polymer, for example of molten polypropylene. The presence of a bifunctional agent, such as methylene diphenyl diisocyanate, capable of reacting with the plasticizer and the amylaceous component, or even also with the polymer, makes it possible to obtain compositions with a high content of amylaceous component having good mechanical properties. This agent is called a “linker”. The compositions are prepared by reactive extrusion. The applicant has also recently envisioned a method for preparing such compositions which makes it possible to reduce the thermal degradation of the amylaceous material, and thus to reduce the coloration of the resins obtained. This method involving the plasticizing of the amylaceous material after melting of the synthetic polymer is described in French application No. PCT/FR2009/051435, filed on Jul. 17, 2009.

The presence of a linker within the compositions described above makes it possible to confer advantageous mechanical properties on them, in particular in terms of elongation at break and maximum tensile strength. However, while the flexible compositions described are suitable in terms of mechanical properties for various fields of application, these properties are not sufficient to cover all the applications that can be envisioned for thermoplastic compositions. Indeed, thermoplastic compositions can be classified mainly into two categories: on the one hand, flexible compositions and, on the other hand, rigid compositions. Certain applications of thermoplastic compositions, for example for certain components used in the automobile industry, require compositions comprising mechanical properties that are intermediate between those of flexible and rigid materials.

Surprisingly, the applicant has shown that increasing the amount of linker well above the amounts necessary for the use described in the abovementioned documents, which amounts are at most equal to 15%, generally at most equal to 10 to 12% and quite particularly between 0.5 and 5%, these percentages being expressed by dry weight of linker relative to the total dry weight of the composition, makes it possible to obtain compositions containing an amylaceous component and a polyolefin which simultaneously have mechanical properties both of a rigid material and of a flexible material. This makes it possible to broaden the field of applications envisioned for these compositions. In particular, the applicant has observed that increasing the content of linker in a flexible composition makes it possible in particular to obtain rigid compositions but while at the same time notably retaining the impact strength of a flexible material.

### DETAILED DESCRIPTION OF THE INVENTION

A subject of the present invention is a method for preparing a thermoplastic composition, which comprises the following steps:
A. introduction into a reactor, for example an extruder, and mixing therein, of an amylaceous component and of a plasticizer for said amylaceous component, under conditions sufficient to obtain plasticizing of the amylaceous component by the plasticizer;
B. addition to the reactor, and mixing therein, of a polyolefin, preferentially softened or molten—it being possible for the softening or the melting either to be carried out beforehand, or to take place during the mixing—and optionally supplemented with a compatibilizing agent;
C. addition to the reactor, and mixing therein, of a linker in an amount greater than 15%, expressed by dry weight relative to the total dry weight of the composition;
D. forming of the composition obtained;
   the method also comprising at least one drying step carried out before step C, and optionally at least one granulation step between steps A and B, and/or B and C, and such that the overall amount of linker added is greater than 15% by weight (dry/dry) relative to the total weight of the composition.

The known composition is given to the set of constituents present at the end of step C. The step of drying the reaction medium can be carried out, for example, between steps B and C.

The method according to the invention can be carried out either continuously, or sequentially.

In one embodiment of the method of the invention, steps A and B constitute just one step (A+B). In this case, the plasticizing of the amylaceous component by the plasticizer for said amylaceous component is carried out within the polyolefin, preferentially softened or molten.

In another embodiment of the method of the invention, steps B and C constitute just one step (B+C), for example when the linker is provided mixed with the polyolefin. In this case, the drying step is carried out before step (B+C).

When the amylaceous component and the plasticizer have a low water content, in particular less than 5% and quite particularly less than 1%, it is possible to carry out a single step A+B+C, i.e. simultaneous addition of the amylaceous component, of the plasticizer, of the polyolefin and of the linker.

Step C—or, where appropriate, step (B+C) or (A+B+C)—can be carried out fractionally, i.e. the linker can be added to the reactor in several stages. In this case, the drying step is carried out before the first addition of linker. If the fractional addition is carried out into the same reactor, it is not necessary to dry between two successive additions.

In one embodiment of the method of the invention, in which step (B+C) is carried out fractionally, one part of the linker is introduced into the reactor mixed with the polyolefin and one or more other parts are introduced afterwards without being mixed beforehand with the polyolefin.

In any event, before any fractional or nonfractional introduction of the linker, it is highly recommended that the intermediate composition into which the linker must be completely or partly introduced has a low water content, in particular less than 5% and quite particularly less than 1%.

The term “drying” denotes in the present invention either drying or dehydration of the reaction medium. This step can in particular be carried out by exposure of the reaction medium to a reduced pressure or to a stream of dry air which is optionally hot.

The drying of the composition in the method according to the invention can in particular be carried out to a residual moisture content of less than 5%, preferably less than 1%, and in particular less than 0.1% by weight relative to the total weight of the composition. Depending on the amount of water to be removed, this drying step can be carried out in batches or continuously during the method. This drying step is particularly important when a linker comprising functions that are reactive with water, amino compounds and/or alcohols is used.

The term “forming” denotes in the present invention a step of granulation of the composition obtained or of direct forming thereof at the reactor outlet by techniques well known to those skilled in the art, for example in the form of tubing, profiled elements or films.

The amount of linker added in step C—or, where appropriate, in step (B+C) or (A+B+C)—is greater than 15% (dry/dry) in accordance with the invention. It may be about from 15.1 to 15.9%, for example. Preferably, it is generally between 16 and 60% by weight relative to the total weight of the composition. More specifically, the amount of linker is from 16 to 50%, preferably from 16 to 40%, even more preferentially from 17 to 35%, or even from 17 to 28%, by weight relative to the total weight of the composition (dry/dry).

The use of an amount of linker greater than 15% by weight in the method according to the invention makes it possible to confer, on the compositions obtained, advantageous mechanical properties, in particular from the point of view of the impact strength (Charpy and/or Izod test), the heat deflection strength under lead (HDT test) and/or the flexural properties. More specifically, compared with a flexible composition containing less than 15% of linker and the same other ingredients, a composition obtained by means of the method according to the invention containing an amount of linker greater than 15% retains good impact strength—typical of a flexible composition—while at the same time having mechanical properties typical of a rigid composition.

Without wishing to be bound by the theory, it appears that increasing the amount of linker within the compositions results in at least partial crosslinking of the amylaceous component and/or of the plasticizer and/or of the polyolefin. This crosslinking results in rigidification of the compositions, in particular it makes it possible to confer, on an initially flexible composition, mechanical properties comparable to those of a rigid composition, without however said composition losing the advantages of a flexible composition, in particular the high impact strength.

The granulation of the mixture in the method according to the invention can in particular be carried out by means of conventional granulation techniques, such as rod granulation, cutting profiled elements, strips or bands of material, and/or by means of granulation using face-cutter systems directly linked to the synthesis reactor; the latter granulations are carried out in vector fluids such as, for example, water, air, mineral oils, vegetable oils, or a mixture thereof.

The temperature at which the softened or molten polyolefin is when it is brought into contact with the plasticized amylaceous component or with the mixture comprising the nonplasticized amylaceous component and the plasticizer may or may not be identical to that at which the plasticizing of the amylaceous component by the plasticizer takes place. In any event, these temperatures are generally between 60° C. and 260° C., preferably between 80° C. and 240° C. These temperatures may in particular be between 120° C. and 200° C., in particular between 130° C. and 190° C., when the polyolefin is chosen from functionalized or nonfunctionalized polyethylenes (PE) and polypropylenes (PP), and mixtures thereof.

In the method according to the invention, the amylaceous component and the plasticizer can be introduced into the reactor separately, either simultaneously or one after the other, with, between these successive additions, optionally a mixing phase and/or a modification of the reactor temperature. The nonplasticized amylaceous component and the plasticizer can be introduced into the reactor via two inlets which are different than one another and which, in addition, may be different than the inlet for the softened or molten polyolefin. When the two components are added simultaneously, this addition can be carried out via two separate inlets, but also via the same inlet.

In one advantageous embodiment, the plasticizer is introduced into the reactor and incorporated into the polyolefin before the introduction of the amylaceous component.

It is particularly advantageous and simple to implement the method according to the invention using an extruder as reactor. It may be a single-screw or twin-screw co-rotating or counter-rotating extruder. Particularly advantageously, the extruder is a twin-screw extruder, in particular a co-rotating twin-screw extruder.

In the method of the present invention, all of steps A to C are generally carried out at a temperature of between 60° C. and 260° C., preferably between 80° C. and 240° C. The provision of heat by means of a suitable heating device is generally, but not systematically, required in order to maintain these temperatures. In certain cases, it is possible to maintain the temperature, in a known manner, by virtue of the shear and compression forces on the mixture of the ingredients, combined with means for heat insulation of the reactor. It is not excluded, in the context of the invention, to introduce the polyolefin into the reactor in a pre-softened or pre-molten state, and in particular at a temperature that is sufficient for only the heat provided by said polyolefin to be sufficient to ensure plasticizing of the amylaceous component by the plasticizer in said reactor. The choice of the temperature profile as a function of the nature and of the viscosity of the polyolefin, of the shear forces implemented, and of the proportions of the various components of the mixture is within the scope of those skilled in the art.

In the method of the present invention, step D of forming, for example in the form of granules or of profiled elements, is very advantageously carried out at a temperature which is reduced in comparison with the temperatures mentioned above for steps A to C, and in particular at a temperature generally between 20° C. and 80° C.

Another subject of the present invention is a thermoplastic composition obtained by means of a method according to the invention.

Particularly advantageous compositions obtained in accordance with the invention comprise:
from 16 to 65%, preferably from 16 to 60% by weight of amylaceous component,
from 5 to 25% by weight of plasticizer for said amylaceous component,
from 16 to 50%, preferably from 16 to 40%, even more preferentially from 17 to 35% by weight of linker, and
from 15 to 65%, preferably from 30 to 45% by weight of polyolefin.

In one embodiment of the invention, the composition obtained by means of the method according to the invention comprises 33% by weight of polyolefin, 30% by weight of amylaceous component, 20% by weight of plasticizer and 17% by weight of linker, the polyolefin being preferentially polypropylene.

As indicated, the proportions of each of the components of the compositions according to the invention correspond to percentages on a “dry/dry” basis, i.e. by weight of dry matter relative to the total weight of the compositions in terms of dry matter. These proportions are indicated relative to the components as introduced into the reactor. However, in the compositions obtained at the end of each of the steps of the method, in particular at the end of the method, these components are not necessarily in this form, in particular since the components are capable of having reacted with one another. Thus, for example, the linker is capable of being covalently bonded, at the end of the method, to the amylaceous component and/or the polyolefin and/or the plasticizer. The compositions according to the invention can nevertheless be analyzed, and the proportions described above can be readily determined by conventional analytical techniques used by those skilled in the art.

The compositions according to the invention can in particular be used:
as resins intended for the direct preparation of injection-molded, rotomolded, calendered, extruded or film-form articles,
as resins intended to be formulated in the form of mixtures with fillers, pigments and/or fibers (mixtures of “compound” type), said mixtures themselves being intended for the direct preparation of articles, for example intended for the motor vehicle or aeronautics industry,
as resins intended to be formulated in the form of mixtures with dyes, antistatic agents, antiblocking agents, stabilizing agents, nucleating agents, crosslinking agents and/or other agents (mixtures of “masterbatch” type), said mixtures themselves being intended for the final preparation of a wide variety of articles,
as additives for synthetic polymers, in particular for polyolefins, with a view to improving the physicochemical and mechanical properties thereof, for example the shockproof or impact strength properties,
as sources of carbon of renewable origin, which may be readily incorporated into synthetic polymers, in particular polyolefins.

Another subject of the present invention is a thermoplastic composition which can be obtained by means of the method according to the invention.

A final subject of the present invention is a thermoplastic composition comprising:
from 16 to 65%, preferably from 16 to 60% by weight of amylaceous component,
from 5 to 25% by weight of plasticizer for said amylaceous component,
from 16 to 50%, preferably from 16 to 40%, and even more preferentially from 17 to 35%, or even from 17 to 28%, by weight of linker, and
from 15 to 65%, preferably from 30 to 45% by weight of polyolefin.

In the same way as that specified above, the proportions of the components of the compositions according to the invention correspond to percentages by weight of dry matter relative to the total weight of the compositions in terms of dry matter, and these proportions are indicated relative to the components as introduced into the reactor in the method having made it possible to obtain said composition.

Description of the Components

Amylaceous Component:

In the present invention, the term “amylaceous component” is intended to mean any oligomer or polymer of D-glucose units linked to one another via alpha-1,4 linkages and optionally other linkages, such as alpha-1,6, alpha-1,2, alpha-1,3, or the like.

The amylaceous component may be a granular starch. The term “granular starch” is intended to mean herein a native starch or a physically, chemically or enzymatically modified starch, which has conserved in the starch granules a semicrystalline structure similar to that found in starch grains naturally present in the storage organs and tissues of higher plants, in particular in cereal seeds, the seeds of leguminous plants, potato or cassava tubers, and roots, bulbs, stems and fruits. This semicrystalline state is essentially due to the amylopectin macromolecules, amylopectin being one of the two main constituents of starch. In native form, the starch grains have a degree of crystallinity ranging from 15 to 45%, which depends essentially on the botanical origin of the starch and on the treatment to which it may have been subjected.

Granular starch, placed under polarized light, has a characteristic black cross, known as a Maltese cross, which is typical of the granular form. For a more detailed description of granular starch, reference may be made to chapter II entitled “Structure et morphologie du grain d'amidon” [Structure and morphology of starch grains] by S. Perez, in the book “Initiation à la chimie et à la physico-chimie macromoléculaires” [Introduction to macromolecular chemistry and physicochemistry], first edition 2000, Volume 13, pages 41 to 86, Groupe Francais d'Etudes et d'Applications des Polymères [French Group for Polymer Studies and Applications].

According to the invention, the granular starch may originate from any botanical source, including a granular starch rich in amylose or, conversely, rich in amylopectin (waxy). It may be native starch of cereals such as wheat, corn, barley, triticale, sorghum or rice, of tuberous plants such as potato or cassava, or of leguminous plants such as pea and soybean, or mixtures of such starches.

According to one variant, the granular starch is a starch that has been hydrolyzed by an acidic, oxidative or enzymatic root, or an oxidized starch. It may be a starch commonly known as fluidized starch or a white dextrin.

According to another variant, it may also be a starch that has been physicochemically modified but that has essentially retained the structure of the starting native starch, such as in particular esterified and/or etherified starches, in particular modified by acetylation, hydroxypropylation, cationization, crosslinking, phosphatation or succinylation, or starches treated in an aqueous medium at low temperature (“annealing”). Preferably, the granular starch is a native, hydrolyzed, oxidized or modified starch, in particular from corn, wheat or pea.

The granular starch generally has a content of matter that is soluble at 20° C. in demineralized water of less than 5% by weight. It is preferably virtually insoluble in cold water.

According to a second variant, the starch selected as amylaceous component is a hydrosoluble starch which may also originate from any botanical source, including a hydrosoluble starch rich in amylose or, conversely, rich in amylopectin (waxy). This hydrosoluble starch may be introduced in partial or total replacement for the granular starch.

For the purpose of the invention, the term “hydrosoluble starch” is intended to mean any amylaceous component having at 20° C. and with mechanical stirring for 24 hours a fraction that is soluble in demineralized water at least equal to 5% by weight. This soluble fraction is preferably greater than 20% by weight and in particular greater than 50% by weight. Of course, the hydrosoluble starch may be totally soluble in demineralized water (soluble fraction=100%).

The hydrosoluble starch may be advantageously used according to the invention in solid form, preferably with a low water content, generally of less than 10%, in particular less than 5%, by weight, and better still in a solid form with a water content of less than 2.5% by weight, including in a substantially anhydrous form (water content of less than 0.5%, or even 0.2%, by weight).

Such hydrosoluble starches can be obtained by pregelatinization on a drum, by pregelatinization on an extruder, by atomization of an amylaceous suspension or solution, by precipitation with a nonsolvent, by hydrothermal cooking, by chemical functionalization or the like. It is in particular a pregelatinized, extruded or atomized starch, a highly transformed dextrin (also known as yellow dextrin), a maltodextrin, a functionalized starch or any mixture of these products.

Pregelatinized starches can be obtained by hydrothermal gelatinization treatment of native starches or of modified starches, in particular by steam cooking, jet-cooker cooking, cooking on a drum, cooking in blender/extruder systems followed by drying, for example in an oven, with hot air on a fluidized bed, on a rotating drum, by atomization, by extrusion or by lyophilization. Such starches generally have a solubility in demineralized water at 20° C. of greater than 5% and more generally between 10 and 100%, and a degree of starch crystallinity of less than 15%, generally less than 5% and most commonly less than 1%, or even zero. By way of examples, mention may be made of the products manufactured and sold by the applicant under the brand name Pregeflo®.

Highly transformed dextrins may be prepared from native or modified starches, by dextrinification in a sparingly hydrated acidic medium. They may in particular be soluble white dextrins or yellow dextrins. By way of examples, mention may be made of the products Stabilys® A 053 and Tackidex® C 072 manufactured and sold by the applicant.

Such dextrins have, in demineralized water at 20° C., a solubility generally of between 10 and 95% and a starch crystallinity of less than 15% and generally less than 5%.

Maltodextrins can be obtained by acid, oxidative or enzymatic hydrolysis of starches in an aqueous medium. They may in particular have a dextrose equivalent (DE) of between 0.5 and 40, preferably between 0.5 and 20 and even better still between 0.5 and 12. Such maltodextrins are, for example, manufactured and sold by the applicant under the trade name Glucidex® and have a solubility in demineralized water at 20° C. generally of greater than 90%, or even close to 100%, and a starch crystallinity generally of less than 5% and usually virtually zero.

Functionalized starches may be obtained from a native or modified starch. The high functionalization may be carried out, for example, by esterification or etherification to a level that is sufficiently high to give it solubility in water. Such functionalized starches have a soluble fraction, as defined above, of greater than 5%, preferably greater than 10%, even better still greater than 50%.

The functionalization can be obtained in particular by acetylation in aqueous phase of acetic anhydride or of mixed anhydrides, hydroxypropylation in adhesive phase, cationization in dry phase or adhesive phase, anionization in dry phase or adhesive phase by phosphatation or succinylation. These highly functionalized hydrosoluble starches may have a degree of substitution of between 0.01 and 3, and even better still between 0.05 and 1.

Preferably, the starch modification or functionalization reagents are of renewable origin. According to another advantageous variant, the hydrosoluble starch is a hydrosoluble starch from corn, wheat or pea or a hydrosoluble derivative thereof.

Furthermore, it advantageously has a low water content, generally of less than 10%, preferably less than 5%, in particular less than 2.5% by weight and ideally less than 0.5%, or even less than 0.2% by weight.

According to a third variant, the amylaceous component selected for the preparation of the composition according to the invention is an organomodified and preferably organosoluble starch, which may also originate from any botanical source, including an organomodified and preferably organosoluble starch that is rich in amylose or, conversely, rich in amylopectin (waxy). This organosoluble starch may be introduced in partial or total replacement for the granular starch or for the hydrosoluble starch.

For the purpose of the invention, the term “organomodified starch” is intended to mean any amylaceous component other than a granular starch or a hydrosoluble starch according to the definitions given above. Preferably, this organomodified starch is virtually amorphous, i.e. has a degree of starch crystallinity of less than 5%, generally less than 1% and in particular zero. It is also preferably “organosoluble”, i.e. it has, at 20° C., a fraction that is soluble in a solvent chosen from ethanol, ethyl acetate, propyl acetate, butyl acetate, diethyl carbonate, propylene carbonate, dimethyl glutarate, triethyl citrate, dibasic esters, dimethyl sulfoxide (DMSO), dimethylisosorbide, glyceryl triacetate, isosorbide diacetate, isosorbide dioleate and methyl esters of vegetable oils, at least equal to 5% by weight. This soluble fraction is preferably greater than 20% by weight and in particular greater than 50% by weight. Of course, the organosoluble starch may be totally soluble in one or more of the solvents indicated above (soluble fraction =100%).

The organomodified starch may be used according to the invention in solid form, including a form with a relatively low water content, namely less than 10% by weight. It may especially be less than 5%, in particular less than 2.5% by weight and ideally less than 0.5%, or even less than 0.2% by weight.

The organomodified starch that can be used in the composition according to the invention may be prepared by high functionalization of native or modified starches such as those presented above. This high functionalization may, for example, be carried out by esterification or etherification to a level that is sufficiently high to make it essentially amorphous and to give it insolubility in water and preferably solubility in one of the above organic solvents. Such functionalized starches have a soluble fraction, as defined above, of greater than 5%, preferably greater than 10%, even better still greater than 50%.

The high functionalization may be obtained in particular by acetylation in a solvent phase with acetic anhydride, grafting, for example in a solvent phase, or by reactive extrusion, of acid anhydrides, of mixed anhydrides, of fatty acid chlorides, of caprolactone or lactide oligomers, hydroxypropylation and crosslinking in adhesive phase, cationization and crosslinking in dry phase or in adhesive phase, anionization by phosphatation or succinylation and crosslinking in dry phase or in adhesive phase, silylation, or telomerization with butadiene. These highly functionalized organomodified, preferably organosoluble, starches may in particular be starch, dextrin or maltodextrin acetates or fatty esters of these amylaceous materials (starches, dextrins, maltodextrins) with fatty chains having from 4 to 22 carbons, all of these products preferably having a degree of substitution (DS) of between 0.5 and 3.0, preferably between 0.8 and 2.8 and in particular between 1.0 and 2.7.

They may, for example, be starch, dextrin or maltodextrin hexanoates, octanoates, decanoates, laurates, palmitates, oleates or stearates, in particular having a DS of between 0.8 and 2.8.

According to another advantageous variant, the organomodified starch is an organomodified starch from corn, wheat or pea, or an organomodified derivative thereof.

According to the invention the amylaceous component may be used with its water of constitution and may thus advantageously have a water content generally of between 10% and 20%, in particular between 12% and 20%, by weight. It may also be used after having been more or less substantially dried, for example such that its water content has been lowered beforehand to a value of less than 10%, in particular less than 7%, by weight. The water content of the amylaceous component used may even be less than 5%, or even less than 2.5%, by weight.

Plasticizer:

In the present invention, the term “plasticizer” for the amylaceous component is intened to mean any molecule of low molecular mass, advantageously less than 5000 g.mol⁻¹, preferably less than 1000 g·mol⁻¹, and in particular less than 400 g.mol⁻¹, which, when it is incorporated into the amylaceous component via a thermomechanical treatment at a temperature generally at least equal to 35° C., preferably between 60° C. and 260° C. and even better still between 65° C. and 200° C., results in a decrease in the glass transition temperature of the amylaceous component and/or in a reduction of the crystallinity thereof, or a mixture of such molecules.

The plasticizer used in the method of the present invention is preferably chosen from water, diols, triols and polyols such as glycerol, polyglycerols, isosorbide, sorbitans, sorbitol, mannitol, and hydrogenated glucose syrups, salts of organic acids, such as sodium lactate, urea and any mixtures of these products. The plasticizer preferably has a molar mass of greater than 18 g.mol⁻¹; in other words, the definition of the plasticizer preferably does not encompass water.

The plasticizer for the amylaceous component, quite particularly when the latter is organomodified, may be chosen from methyl or ethyl esters or organic fatty acids such as lactic acid, citric acid, succinic acid, adipic acid and glutaric acid, or acetic esters or fatty esters of monoalcohols, diols, triols or polyols such as ethanol, diethylene glycol, glycerol and sorbitol. By way of examples, mention may be made of glyceryl diacetate (diacetin), glyceryl triacetate (triacetin), isosorbide diacetate, isosorbide dioctonate, isosorbide dioleate, isosorbide dilaurate, dicarboxylic acid esters or dibasic esters (DBE) and any mixtures of these products.

The plasticizer is advantageously used in a proportion of from 10 to 150%, preferably in a proportion of from 25 to 120% and in particular in a proportion of from 40 to 120% by weight, relative to the weight of amylaceous component.

Linker

In the present invention, the term “linker” is intended to mean any molecule comprising at least two reactive functions, capable of reacting with the amylaceous component and/or the polyolefin and/or the plasticizer. The linker may also react with the compatibilizing agent. The molar mass of the linker may be less than 5000 g/mol and preferably less than 1000 g/mol. In this preferred molar mass range, the linker readily reacts with the amylaceous component and/or the plasticizer or even the compatibilizing agent. This linking of the various ingredients to one another gives the thermoplastic amylaceous compositions of the present invention the advantageous properties specified above. By way of linkers that can be used in the present invention, mention may be made of:
diisocyanates, preferably methylene diphenyl diisocyanate (MDI), isophorone diisocyanate (IPDI), dicyclohexylmethane diisocyanate (H12MDI), toluene diisocyanate (TDI), naphthalene diisocyanate (NDI), hexamethylene diisocyanate (HMDI), lysine diisocyanate (LDI) or the aliphatic diisocyanate with a molar mass of 600 g/mol obtained from fatty acid dimers (DDI®1410 diisocyanate),
diisocyanate dimers, trimers and tetramers,
triisocyanates, tetraisocyanates and also the respective homopolymers of existing di-, tri- and tetraisocyanates,
“isocyanate-free” prepolymers resulting from reaction of a diol or of an amino compound with a diisocyanate under conditions such that the prepolymer contains an isocyanate function at each of its ends (α,Ω-functional or telechelic polymer) without free diisocyanate being able to be detected,
prepolymers of isocyanate of dendrimer type prepared from compounds having several alcohol or amino functions and polyisocyanates prepared in such a way that the dendrimer formed has only reactive isocyanate functions at the end of a branch, the dendrimer possibly containing free diisocyanates or triisocyanates,
dialkyl carbonates, especially dianhydrohexitol dialkyl carbonates, and in particular isosorbide dialkyl carbonates,
dicarbamoylcaprolactams, preferably 1,1′-carbonylbiscaprolactam,
diepoxides,
compounds comprising an epoxide function and a halo function, preferably epichlorohydrin,
organic diacids, preferably succinic acid, adipic acid, glutaric acid, oxalic acid, malonic acid or maleic acid, or the corresponding anhydrides,
polyacids and polyanhydrides, preferably mellitic acid or derivatives thereof, such as trimellitic acid or pyromellitic acid,
oxychlorides, preferably phosphorus oxychloride,
trimetaphosphates, preferably sodium trimetaphosphate,
alkoxysilanes, preferably tetraethoxysilane,
heterocyclic compounds, preferably bis-oxazolines, bis-oxazolin-5-ones and bis-azalactones,
methylenic or ethylenic diester derivatives, preferably methyl or ethyl carbonate derivatives,
any mixtures of at least any two of the abovementioned products.

The isocyanates, epoxides and alkoxysilanes mentioned above are particularly preferred linkers.

Particularly preferably, a diisocyanate, and in particular methylene diphenyl diisocyanate (MDI), is used as linker. Moreover, the use of isophorone diisocyanate (IPDI) or of dicyclohexylmethane diisocyanate (H12MDI) makes it possible to obtain final compositions that are particularly sparingly colored. Any mixture of at least any two of the abovementioned three diisocyanates (MDI, IPDI, H12MDI) may be used.

It is specified that the linker is of course different than the compatibilizing agent described hereinafter.

Polyolefin

In the present invention, the term “polyolefin” is intended to mean a nonfunctionalized or nongrafted polyolefin. The polyolefin must of course withstand chemical degradation at the maximum temperature used in the method according to the invention.

The polyolefin can be obtained from monomers of fossil origin and/or from monomers resulting from renewable natural resources, as it can result from a source of recycled material or material to be recycled.

By way of examples of nonfunctionalized or nongrafted polyolefins that can be used in the context of the present invention, mention may in particular be made of:

a) olefin homopolymers, for instance linear or radical low-density polyethylenes (LDPE), high-density polyethylenes (HDPE), polypropylenes (PP) of isotactic, syndiotactic or atactic form, polybutenes and polyisobutylenes,

b) copolymers based on at least two olefins, for instance ethylene-propylene (P/E) copolymers, ethylene-butene copolymers and ethylene-octene copolymers,

c) any mixtures of at least any two of the abovementioned products.

The polyolefin may in addition be synthesized from monomers derived from rapidly renewable natural resources, such as plants, microorganisms or gases. It may in particular be polyethylene derived from bioethanol or polypropylene derived from biopropanediol.

Preferably, the polyolefin is chosen from polyolefins obtained from biobased monomers, and mixtures thereof.

Advantageously, the polyolefin has a weight-average molecular weight of between 8500 and 10 000 000 g·mol⁻¹, in particular between 15 000 and 1 000 000 g.mol⁻¹.

According to another preferential variant, the polyolefin is a nonbiodegradable and noncompostable polyolefin within the meaning of standards EN 13432, ASTM D 6400 and ASTM D 6868. It may in particular be nonbiodegradable.

According to another preferential variant, the polyolefin is a polyolefin containing at least 15%, preferably at least 30%, in particular at least 50%, even better still at least 70%, or even more than 80%, of carbon of renewable origin within the meaning of standard ASTM D 6852 and/or standard ASTM D 6866, relative to all the carbon present in said polyolefin.

Compatibilizing Agent

In the present invention, the term “compatibilizing agent” is intended to mean a compound which makes it possible to obtain satisfactory compatibilization between the polyolefin and the plasticized amylaceous component. The term “compatibilization” is intended to mean the formation of a homogeneous and stable mixture during the implementation of the preparation method and at the end of said method.

This compatibilizing agent may be a functionalized or grafted polyolefin. The functionalizaton of the polyolefin can take place in the same reactor in which the method according to the invention is carried out, for example by reactive extrusion. This functionalization can in particular take place on-line on a polyolefin in the softened or molten state before said polyolefin is brought into contact with the amylaceous component and/or the plasticizer.

As was explained above, a linker is incorporated into the compositions of the present invention. In order for such a linker to be able, in addition, to react with the compatibilizing agent, at least a part of the latter must comprise reactive groups, i.e. groups capable of reacting with at least one of the functions of the linker.

The reactive groups of this compatibilizing agent are in particular chosen from carboxylic acid, acid anhydride, amino, amide, carbonate, sulfone, imide, urethane, epoxide, hydroxyl, alkoxysilane, oxazoline, oxazolin-5-one and ester functions.

Thus, according to one variant of the invention, the compatibilizing agent optionally added is chosen from:

a) homopolymers of olefins which are functionalized or grafted, for example with acids or anhydrides, such as maleic acid (or anhydride), acrylic acid (or anhydride) and methacrylic acid (or anhydride), for instance maleic anhydride-grafted polyethylenes and polypropylenes, with oxiranes, such as glycidyl methacrylate or glycidyl acrylate, or with silanes;

b) copolymers based on at least two olefins, for instance functionalized or grafted ethylene-propylene (P/E) copolymers, for instance:
acids or anhydrides such as maleic acid (or anhydride), acrylic acid (or anhydride) and methacrylic acid (or anhydride), for instance maleic anhydride-grafted polyethylenes and polypropylenes,
oxiranes such as glycidyl methacrylate or glycidyl acrylate, and/or
silanes;

c) copolymers based on at least one olefin and on at least one non-olefin monomer, for instance ethylene-acrylic ester copolymers or ethylene-vinyl ester copolymers, such as ethylene-vinyl acetate (EVA), ethylene-methyl acrylate (EMA) or ethylene-vinyl alcohol (EVOH) copolymers;

d) ethylene-acrylic ester-maleic anhydride or glycidyl methacrylate terpolymers;

e) styrene-acrylic ester-maleic anhydride or glycidyl methacrylate copolymers;

f) any blends of at least any two of the abovementioned products.

Advantageously, the compatibilizing agent has a weight-average molecular weight of between 8500 and 10 000 000 g.mol⁻¹, in particular between 15 000 and 1 000 000 g.mol⁻¹.

Additives

Additives of any nature can be incorporated into the composition of the invention. Although the proportion of these additional ingredients can be quite high, the amylaceous component, the plasticizer, the polyolefin and the linker represent, together, preferably at least 30%, more preferentially at least 40% and in particular at least 50%, by weight (dry/dry), of the composition. According to one preferential variant, this overall proportion is at least equal to 80% by weight (dry/dry) of the composition.

The additive may be an agent for improving or adjusting the mechanical or thermal properties, chosen from minerals, salts and organic substances, in particular from nucleating agents such as talc, compatibilizing agents such as surfactants, agents for improving the impact strength or the scratch resistance, such as calcium silicate, shrinkage regulators such as magnesium silicate, agents for trapping or deactivating water, acids, catalysts, metals, oxygen, infrared rays or UV rays, hydrophobizing agents such as oils and fats, hygroscopic agents such as pentaerythritol, flame retardants and fireproofing agents such as halogenated derivatives, smoke retardants, inorganic or organic reinforcing fillers, such as clays, carbon black, talc, plant fibers, glass fibers, polyacrylonitrile or kevlar.

The additive may also be an agent for improving or adjusting the conductive or insulating properties with respect to electricity or heat, the leaktightness, for example to air, water, gases, solvents, fatty substances, spirits, flavors and fragrances, chosen in particular from minerals, salts and organic substances.

The additive may also be an agent for improving the organoleptic properties, in particular:
the odor properties (fragrances or odor-masking agents),
the optical properties (gloss agents, whitening agents such as titanium dioxide, dyes, pigments, dye extenders, opacifiers, matting agents such as calcium carbonate, thermochromic agents, phosphors and fluorophores, metalizing or marbling agents and antifogging agents),
the acoustic properties (barium sulfite and barites), and
the tactile properties (fats).

The additive may also be an agent for improving or adjusting the adhesive properties, in particular the adhesion to cellulose-based materials such as paper or wood, metals such as aluminum and steel, glass or ceramic materials, textile and minerals, such as in particular pine resins, colophony, ethylene vinyl alcohol copolymers, fatty amines, lubricants, release agents, antistatic agents and antiblocking agents.

Finally, the additive may be an agent for improving the durability of the material or an agent for controlling its (bio)degradability, in particular chosen from hydrophobizing agents such as oils and fats, anticorrosion agents, antimicrobial agents such as Ag, Cu and Zn, degradation catalysts such as oxo-catalysts and enzymes such as amylases.

The compositions according to the invention may also comprise one or more compatibilizing agents intended to compatibilize the starch and the polyolefin. By way of example of such compatibilizing agents, mention may, for example, be made of the functionalized polyolefins as described in the “polyolefin” section.

The compositions according to the invention are not very flexible and advantageously have a flexural modulus greater than or equal to 1000 MPa, preferentially greater than or equal to 1300 MPa, or even greater than or equal to 1400 MPa. The flexural modulus is measured according to standard ISO 178.

Advantageously, the compositions have an unnotched Charpy impact strength of greater than 140 kJ/m², according to standard EN ISO 179-1.

The examples hereinafter are provided by way of nonlimiting illustration of the present invention.

Unless otherwise indicated, the percentages in the present invention are expressed by dry weight relative to the total dry weight of the composition.

### EXAMPLES

Description of the Characterization Tests:

Degree of Swelling and Content of Insoluble Matter

The content of water-insoluble matter is determined according to the following protocol:
(i) Dry the sample of composition to be characterized (12 hours approximately at 80° C. under vacuum).
(ii) Measure the mass of the sample (=Ms1) with a precision balance.
(iii) Immerse the sample in water, at 20° C. (volume of water in ml equal to 100 times the mass in g of sample).
(iv) Collect the sample after a defined time of several hours.
(v) Remove the excess surface water with blotting paper, as quickly as possible.
(vi) Place the sample on a precision balance and monitor the loss of mass for 2 minutes (measurement of the mass every 20 seconds).
(vii) Determine the mass of the swollen sample by graphic representation of the preceding measurements as a function of time and extrapolation to t=0 of the mass (=Mg).
(viii) Dry the sample (for 24 hours at 80° C. under vacuum). Measure the mass of the dry sample (=Ms2).
(ix) Calculate the content of insoluble matter, expressed as a percentage, according to the formula Ms2/Ms1.
(x) Calculate the degree of swelling, as a percentage, according to the formula (Mg−Ms1)/Ms1.

Charpy Test

The purpose of the Charpy impact test is to measure the sudden breaking strength of a material. This test is intended to measure the energy necessary to break a test specimen by one blow. A pendulum impact testing machine fitted at its end with a knife, which makes it possible to develop a given energy at the moment of impact, is used.

The energy absorbed is obtained by comparing the difference in potential energy between the start of the pendulum and the end of the test. The machine has a graduation which makes it possible to determine the height of the pendulum at the start and also the highest position reached by the pendulum after breaking of the test specimen. The graduation of the machine generally makes it possible to directly obtain an energy value in joules.

There are various standards for this test:
American (ASTM):
   ASTM E23: Standard test methods for notched bar impact testing of metallic materials.
European (CEN):
   EN 10045-1: Charpy impact test on metallic materials—part 1: test method.
   EN 10045-2: Charpy impact test on metallic materials—part 2: method for the verification of impact testing machines.
International (ISO)
   EN ISO 179-1: Plastics—determination of Charpy impact properties—part 1: non-instrumented impact test
   EN ISO 179-2: Plastics—determination of Charpy impact properties—part 2: instrumented impact test.

In the present examples, the unnotched Charpy impact strength measurements are carried out according to standard EN ISO 179-1.

Ten test specimens were tested in order to measure the impact strength properties. The dissipated energy calculated according to the standard is shown in the “Charpy impact” column of table 1. The number of test specimens which did not break under the impact is given between parentheses in the same column.

HDT Test

The heat deflection temperature (HDT) is a relative measure of the ability of the material to be affected for a short period of time at high temperatures while under load. The test measures the effect of temperature on consistency: a standard test sample is subjected to a given surface tension and the temperature is raised at constant speed.

The standards which describe this test are standards ASTM D648, ISO 75 and ASTM D648-98c.

In the present examples, the HDT measurements are carried out with a load of 0.45 MPa (HDT/B), according to standard ISO 75.

Flexural Test

The flexural modulus is measured according to standard ISO 178 using a Lloyd Instruments LR5K testing bench.

Measurement of the Tensile Mechanical Properties

The tensile mechanical characteristics of the various samples are determined according to standard NF T51-034 (determination of tensile properties) using a Lloyd Instruments LR5K testing bench, a traction speed: 50 mm/min and standardized test specimens of H2 type.

### Example 1

### Mechanical Properties of Compositions According to the Invention and Comparison with Compositions Comprising Lower Linker Contents

The objective of this example is to demonstrate that the incorporation of a linker content of greater than 15% makes it possible to improve the mechanical properties of the compositions. A composition obtained by means of the method according to the invention has the mechanical properties of a rigid composition and the impact strength of a flexible composition.

Constituents of the Composition:

Native starch: “Wheat starch SP” sold by the applicant, having a water content of approximately 12%;

Plasticizer: composition containing glycerol and sorbitol, having a water content of approximately 16%;

Polyolefin: polypropylene;

Compatibilizing agent: maleic anhydride-grafted polypropylene;

Linkers:
methylene diphenyl diisocyanate (MDI);
sodium trimetaphosphate (STMP);
tetraethoxysilane (TEOS).

The groups of compositions 1 comprise, by dry weight, approximately 35% of native starch, 15% of plasticizer, 25% of polyolefin and 25% of maleic anhydride-grafted polypropylene, relative to the sum of these four constituents.

The groups of compositions 2, 3 and 4 comprise, by dry weight, approximately 30% of native starch, 20% of plasticizer, 25% of polyolefin and 25% of maleic anhydride-grafted polypropylene, relative to the sum of these four constituents.

The mechanical properties of the compositions according to the invention and comparative compositions are recorded in the following table.

| | | Charpy impact | | | Tensile mechanical | |
|---|---|---|---|---|---|---|
| | Linker | Energy | | Flexure | characteristics | |
| | content | dissipated | HDT B | Modulus | σ_{threshold} | |
| | (%) | (kJ/m²) | T (° C.) | (MPa) | (MPa) | ε_{break} (%) |
| Compositions 1 | 0 | >190 (10) | 56 | 660 | 18 | 190 |
| Linker = MDI | 5 | >190 (10) | 60 | 1180 | 20 | 110 |
| | 10 | >190 (10) | 60 | 1280 | 20 | 120 |
| | 15 | >190 (10) | 60 | 1350 | 20 | 50 |
| | 20 | >190 (10) | 62 | 1480 | 20 | 55 |
| Compositions 2 | 0 | >190 (10) | 46 | 340 | 14 | 650 |
| Linker = MDI | 10 | >190 (10) | 58 | 1150 | 21 | 220 |
| | 14 | >190 (10) | 60 | 1250 | 23 | 180 |
| | 17 | >190 (10) | 63 | 1380 | 24 | 100 |
| | 20 | >190 (10) | 64 | 1500 | 24 | 93 |
| | 30 | >140 (7) | 98 | 2240 | 26 | 53 |
| Compositions 3 | 0 | >190 (10) | 46 | 340 | 14 | 650 |
| Linker = STMP | 20 | >190 (10) | 51 | 1030 | 22 | 48 |
| Compositions 4 | 0 | >190 (10) | 46 | 340 | 14 | 650 |
| Linker = TEOS | 20 | >190 (10) | 47 | 1060 | 18 | 491 |

The linker percentages indicated are percentages by weight relative to the total weight of the composition, the rest consisting of the mixture of native starch, plasticizer, polyolefin and compatibilizing agent in the proportions previously defined.

The increase in deflection temperature under load of the compositions obtained by means of the method according to the invention, relative to the compositions comprising lower linker contents, shows that the compositions according to the invention have mechanical properties similar to those of rigid compositions.

Likewise, the increase in the flexural modulus of the compositions obtained by means of the method according to the invention shows that these compositions are more rigid than those comprising lower linker contents.

The energies dissipated in the Charpy impact are as high in the compositions obtained by means of the method according to the invention as in the compositions comprising lower linker contents. This shows that, despite the rigidification, there is little or no loss of impact strength of the materials. The impact strength of the compositions according to the invention is similar to that of flexible compositions. Indeed, even when the linker content reaches 30% of the total mass, only 3 of the 10 test specimens broke under the effect of the impact. The compositions of the invention exhibit a dissipated energy of at least greater than 140 kJ/m², i.e. an excellent impact resistance.

Moreover, the compositions according to the invention also exhibit excellent tensile behavior, as shown by the high breaking strengths.

### Example 2

### Preservation of the Low Water-Sensitivity Properties Compared with the Compositions Comprising Lower Linker Contents

The objective of this example is to demonstrate that the compositions obtained by means of the method according to the invention exhibit water resistance that is as good as that of the compositions comprising lower linker contents.

| | Linker | Degree of | Content of insoluble |
|---|---|---|---|
| | content (%) | swelling (%) | matter (%) |
| Composition 1 | 0 | 3.1 | 100.0 |
| | 5 | 8.7 | 100.0 |
| | 10 | 5.1 | 100.0 |
| | 15 | 3.8 | 100.0 |
| | 20 | 4.6 | 100.0 |
| Composition 2 | 0 | 2.6 | 99.5 |
| | 10 | 2.7 | 99.6 |
| | 14 | 2.4 | 99.9 |
| | 17 | 2.2 | 100.0 |
| | 20 | 1.7 | 99.8 |
| | 30 | 1.1 | 100.0 |
| Composition 3 | 0 | 2.6 | 99.5 |
| | 20 | 10.1 | 99.4 |
| Composition 4 | 0 | 2.6 | 99.5 |
| | 20 | 9.1 | 99.7 |

The degrees of swelling and contents of insoluble matter of the compositions according to the invention are given in the table above and compared with those of compositions comprising lower linker contents. These values attest to the fact that, when the amount of linker in the compositions is increased in order to give them mechanical properties different than those of the compositions previously described, their water resistance is not affected. In other words, the improvement in the mechanical properties of the compositions does not occur to the detriment of their other properties.

1-18. (canceled)

19. A method for preparing a thermoplastic composition, wherein said method comprises the following steps:
A) introduction into a reactor and mixing therein an amylaceous component and a plasticizer for said amylaceous component under conditions sufficient to obtain plasticizing of the amylaceous component by the plasticizer;
B) addition to the reactor, and mixing therein, a polyolefin, ionally supplemented with a compatibilizing agent;
C) addition to the reactor and mixing therein a linker in an amount greater than 15%, expressed by dry weight relative to the total dry weight of the composition; and
D) forming of the composition obtained;
the method also comprising at least one drying step carried out before step C, and such that the overall amount of linker added is greater than 15%, expressed by dry weight relative to the total dry weight of the composition.

20. The method according to claim 19, in which the drying step is carried out between steps B and C.

21. The method according to claim 19, in which steps A and B constitute just one step (A+B).

22. The method according to claim 19, in which steps B and C constitute just one step (B+C).

23. The method according to claim 19, in which the amount of linker is between 16 and 60%by dry weight relative to the total dry weight of the composition

24. The method according to claim 19, in which the reactor is an extruder.

25. The method according to claim 19, in which all of steps A to C are carried out at a temperature of between 60° C. and 260° C.

26. The method according to claim 19, in which the linker selected from the group consisting of
diisocyanates, triisocyanates, tetraisocyanates, and also the respective homopolymers of di-, tri- and tetraisocyanates,
diisocyanate dimers, trimers and tetramers,
“isocyanate-free” prepolymers,
prepolymers of isocyanate of dendrimer type,
dialkyl carbonates,
dicarbamoylcaprolactams,
compounds comprising an epoxide function and a halo function,
organic diacids and cyclic anhydrides,
polyacids and polyanhydrides,
oxychlorides,
trimetaphosphates,
alkoxysilanes,
heterocyclic compounds,
methylenic or ethylenic diester derivatives, and
any mixtures of at least any two of the abovementioned linkers.

27. The method according to claim 26, in which the linker is selected from the group consisting of methylene diphenyl diisocyanate (MDI), isophorone diisocyanate (IPDI), dicyclohexylmethane diisocyanate (H12MDI) and mixtures thereof.

28. The method according to claim 19, in which the amylaceous component is selected from the group consisting of a granular starch, a hydrosoluble starch, an organomodified starch and mixtures thereof.

29. The method according to claim 19, in which the plasticizer is selected from the group consisting of water, diols, triols and polyols, polyglycerols, isosorbide, sorbitans, sorbitol, mannitol, hydrogenated glucose syrups, salts of organic acids, urea, and mixtures thereof.

30. The method according to claim 19, in which the plasticizer has a molecular mass of less than 5000 g·mol⁻¹.

31. The method according to claim 19, in which the polyolefin is selected from the group consisting of olefin homopolymers, functionalized or grafted olefin homopolymers, copolymers based on at least two olefins, copolymers based on at least two functionalized or grafted olefins, and mixtures thereof.

32. The method according to claim 19, in which the mixture introduced into the reactor comprises a compatibilizing agent.

33. A thermoplastic composition obtained or which can be obtained by the method of claim 19.

34. The composition according to claim 33, comprising:
from 16 to 65% by weight of amylaceous component,
from 5 to 25% by weight of plasticizer for said amylaceous component,
from 16 to 50% by weight of linker, and
from 15 to 65% by weight of polyolefin.

35. The composition according to claim 34, comprising 33% by weight of polyolefin, 30% by weight of amylaceous component, 20% by weight of plasticizer and 17% by weight of linker, in which the polyolefin is polypropylene.

36. An amylaceous thermoplastic composition comprising:
from 16 to 65% by weight of amylaceous component,
from 5 to 25% by weight of plasticizer for said amylaceous component,
from 16 to 50% by weight of linker, and
from 15 to 65% by weight of polyolefin.
